(19) United States
(12) Patent Application Publication
(10) Pub. No.: US 2025/0280064 A1
(43) Pub. Date: Sep. 4, 2025

(54) SUN SHADE FOR CELL PHONES

(71) Applicant: Christopher Andrews, Nevada City, CA (US)

(72) Inventor: Christopher Andrews, Nevada City, CA (US)

(21) Appl. No.: 18/594,476

(22) Filed: Mar. 4, 2024

(51) Int. Cl. H04M 1/18; H04M 1/03

(52) U.S. Cl. CPC H04M 1/18; H04M 1/03

(57) ABSTRACT

A portable enclosure for cell phones and electronic devices that provides a sun shade while allowing the transmission of sound there from. The enclosure defines a rectangular shape with a hinge top portion having a deployable sound shade and support panels there within. During use, the hinge top portion is open allowing the placement of a cell phone within the base portion and the sound transmission and support panels hinge from the top portion forming a shade enclosure that contains and direct sound thought the sound panel. Selective access is achieved by lifting the hinge sound transmission and shade panel.

### BACKGROUND OF THE INVENTION

### 1. Technical Field

This invention relates to cell phone enclosures that provide shade to prevent the electronic equipment from overheating in the direct sunlight.

### 2. Description of Prior Art

Prior art devices of this type have been developed to provide temporary shade for electronic devices by having a shade configuration, see for example U.S. Pat. No. 9,351,415 discloses a folding sun shade having pairs of semi-circular panels that unfold around a cell phone to form an open top partial enclosure for shade.

U.S. Pat. No. 9,806,756 claims a cell phone case with a shade that retracts into a portion of the phone case and then deploys defining an awning configuration type shade over a portion of the phone.

U.S. Pat. No. 10,368,622 discloses a glare shield with an open front that fits onto the rear surface of a mobile phone. When unfolded, it overlies the phone screen allowing for access to the power jack's control switches, etc. and thereby reduces the glare on the phone screen in sunlight.

U.S. Publication 2013/0148204 shows a deployable visor configuration for shielding a flat panel display. It has slidable panels and supports that deploy the panels for selected use.

U.S. Publication 2014/0349719 discloses an adjustable folding shade for a cell phone with a top and two oppositely disposed side panels forming an open upstanding enclosure to shade the cell phone screen.

### SUMMARY OF THE INVENTION

The shade enclosure for a cell phone and the like has a deployable sound transparent shade panel with end support panels. The enclosure has a phone receiving base with a hinge closure top from which the shade and support panels are hinged.

The sound transparent shade panel provides a maximum surface for sound transmission therethrough and to shade the phone positioned there within. The end support panels are shaped to fold into the hinge top and then deploy to support the shade panel and top in an angular hinged open position with the sound transparent panel in place for a full shade enclosure that contains and direct sound out through the sound panel.

### DESCRIPTION OF THE DRAWINGS

FIG. 1 is a perspective view of the sound and shade enclosure in open use position.

FIG. 2 is a perspective view thereof in folded closed transport position.

FIG. 3 is an end elevational view with the end and sound panel deployment positions shown in solid and broken lines.

FIG. 4 is an enlarged bottom plan view of the top portion with folded support panels and deployed sound shade panel.

FIG. 5 is a perspective view of the sound and shade enclosure in open position with unfolded end panels and sound shade panel being open.

FIG. 6 is a front elevational view of the sound and shade enclosure in deployed open use position.

### DETAILED DESCRIPTION OF THE INVENTION

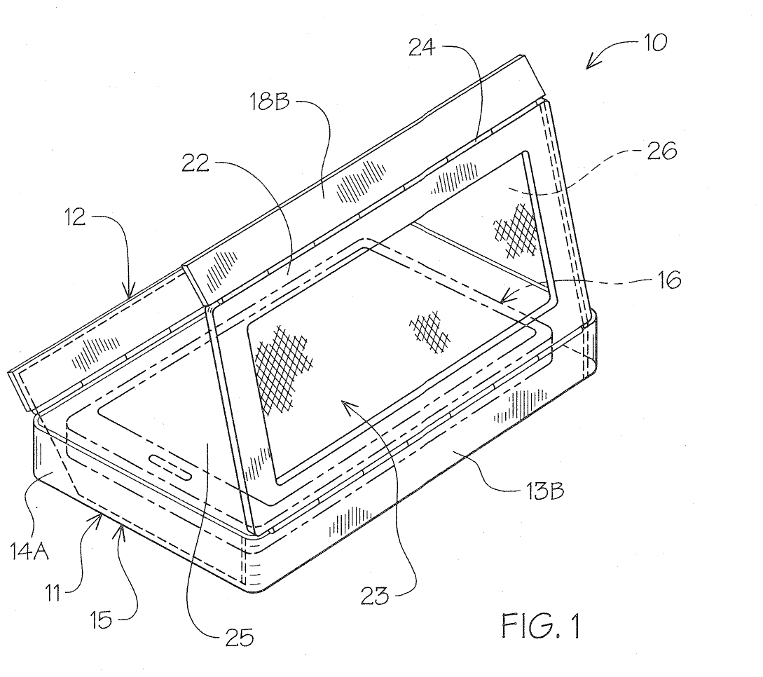

Referring now to FIGS. 1-5 of the drawings, the sound and shade enclosure 10 of the invention for cell phones and the like can be seen having a rectangular base 11 and a hinged closure top 12. The based 11 has spaced parallel oppositely disposed upstanding sidewalls 13A and 13B with interconnecting opposing end walls 14A and 14B and an integral bottom 15 there between. The base 11 defines an open top enclosure for receiving an electronic communication device, cell phone 16, there within shown in broken lines. The closure top 12 having corresponding dimension to the hereinbefore described base is hinged to the base sidewall 13A. The closure top 12 has, as noted, a corresponding upstanding sidewalls 18A and 18B, interconnecting end walls 19A and 19B and a corresponding interconnected top surface 20 as will be well understood by those skilled in the art.

As noted, the closure top 12 is hinged to the base 11 by an interlocking hinge configuration 21 along its abutting sidewalls 18A and 13A.

This allows for the closure top 12 to close on the base 11 for phone storage or transport as illustrated in FIG. 2 of the drawings.

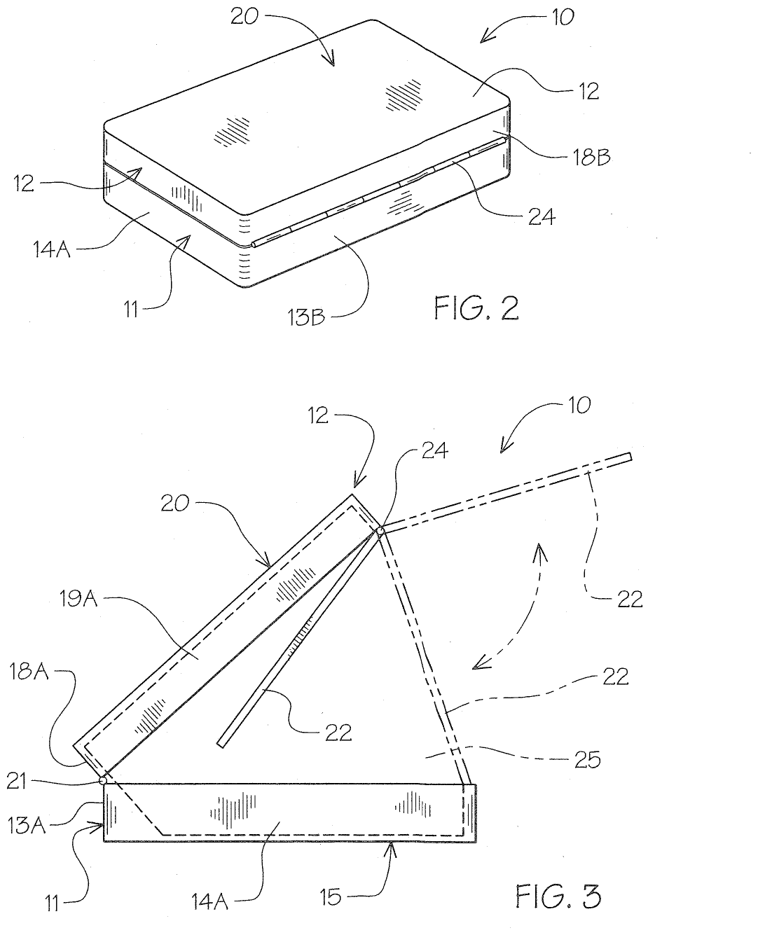

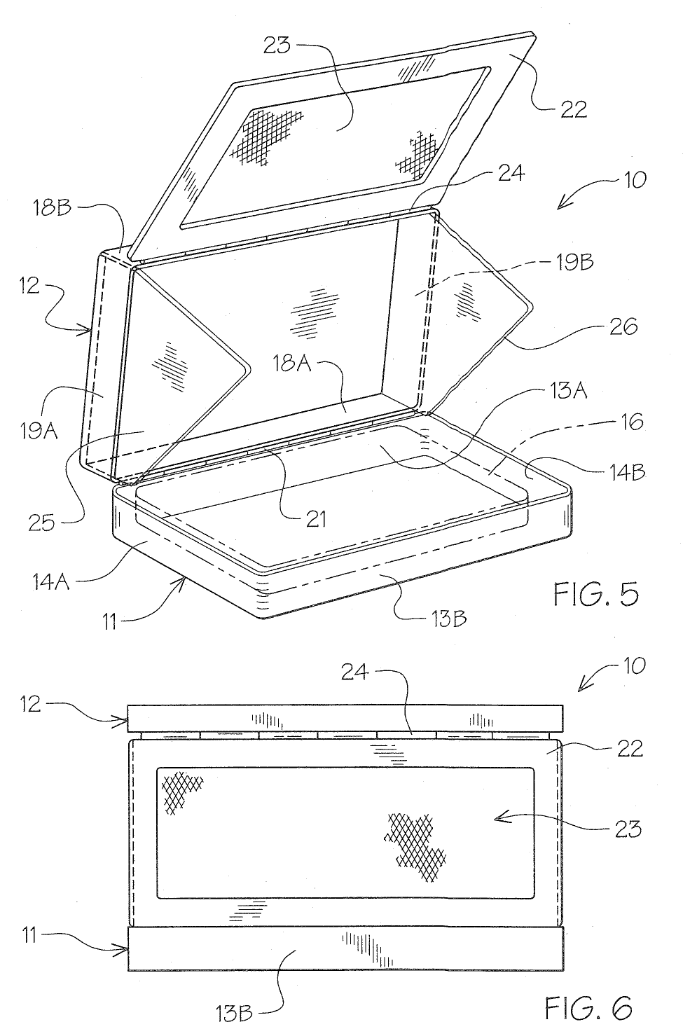

A sound panel 22 is provided of a rectangular dimension with a center sound transparent area 23 within which will allow for the sound transmission there through. The sound panel 22 is pivotally secured to the free edge of the top solid wall 18B by a continuous hinge 24 that will allow the sound panel 22 to be folded up inside the closure top 12 and unfolded during use as seen in FIGS. 3 and 5 of the drawings.

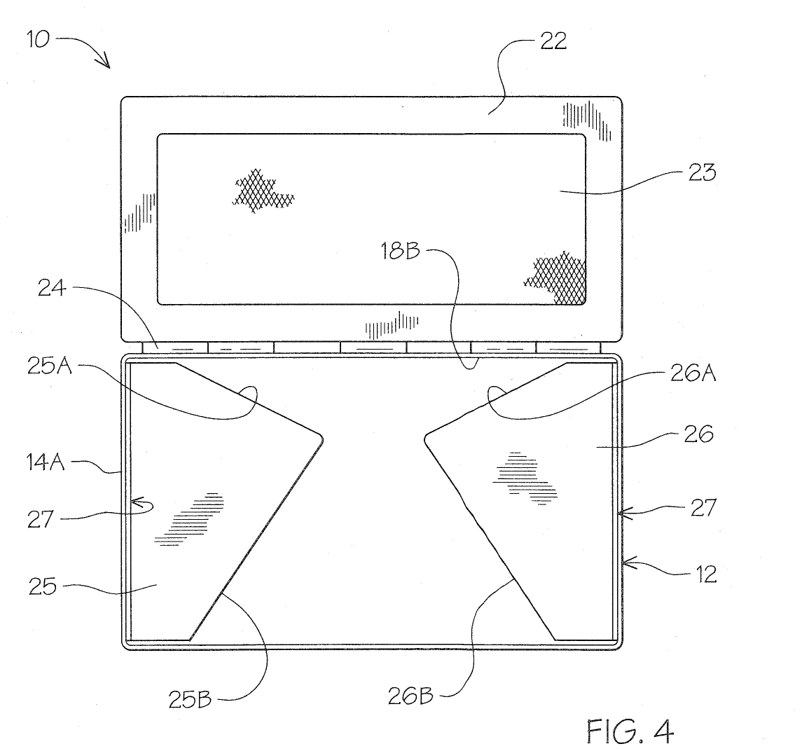

A pair of identical end support panels 25 and 26 are hinged at 27 to the inner top surface 28 of the closure top 12 adjacent the respective top end walls 19A and 19B, best seen in FIGS. 4 and 5 of the drawings. Each of the end support panels 25 and 26 have a sound panel support edge 25A and 26A and a bottom engagement edge 25B and 26B. In use, the closure top 12 is opened and the sound panel 22 is first hinged outwardly as seen in FIGS. 3 and 5 of the drawings allowing for the deployment of the respective sound support panels 25 and 26 from inside the closure top 12 interior top surface 27 indicated by directional arrows A in FIG. 5 of the drawings.

The closure top 12 is then partially closed with the hereinbefore disclosed engagement of the end support panels 25 and 26 in the base 11 for support and the sound panel 22 is then hinged down to engage on the now angularly positioned sound panel support edges 25A and 26A defining a shade enclosure for the cell phone 16 there within as seen best in FIG. 1 of the drawings.

It will be evident from the disclosure that the sound panel 22 will allow the now shaded cell phone 16 to be heard clearly outside the sound and shade enclosure 10. It will also be apparent that it will allow for ease of phone access by simply lifting up the freely hinged sound panel 22 for quick access and removal of the phone as needed.

It will thus be seen that a new and novel sun shade and sound enclosure for cell phones and electronic devices have been illustrated and described and it will be apparent to those skilled in the art that various changes and modifications may be made thereto without departing from the spirit of the invention.

Therefore, I claim:

1. A shade and sound enclosure for a cell phone comprising,
a base enclosure portion and a top enclosure portion hinged together,
said base enclosure portion having upstanding sidewalls and interconnecting end walls,
said top enclosure portion having upstanding sidewalls at interconnecting end walls there between,
a sound panel hinged from one of said top portion's sidewalls movable from a first position to a second position,
a pair of oppositely disposed sound panel supports hinged from said top portion.

2. The shade and sound enclosure set forth in claim 1 wherein said base enclosure and said top enclosure are of equal registration dimension and aligned with one another when in hinged closed position.

3. The shade and sound enclosure set forth in claim 1 wherein said sound panel and said sound panel supports are configured so that they can fold within said top enclosure portion.

4. The shade and sound enclosure set forth in claim 1 wherein said sound panel and said sound panel supports upon deployment will define a shade and sound transparent enclosure.

5. The shade and sound enclosure set forth in claim 1 wherein the dimensions of said sound panel is less than the known dimension of said top enclosure portion.

6. The shade and sound enclosure set forth in claim 1 wherein said sound panel has a sound transparent surface.

7. The shade and sound enclosure set forth in claim 1 wherein said base and top enclosure portions are of a rectangular dimensional configuration.

8. The shade and sound enclosure set forth in claim 1 wherein said sound panel supports folding sequentially in both collapsing and deployment positions.

9. The shade and sound enclosure set forth in claim 1 wherein said top enclosure portion is movable from a first closed position in registration on said base enclosure portion to a second open position in angular orientation to said base enclosure portion.

10. The shade and sound enclosure set forth in claim 1 wherein said sound panel first position is folded within said top enclosure portion and said second position is hinged from said top enclosure to one of said base portion sidewalls ad said respective sound panel supports.
